(19) United States
(12) Patent Application Publication
(10) Pub. No.: US 2026/0279294 A1
(43) Pub. Date: Sep. 17, 2026

(54) LIQUID CRYSTAL DISPLAY APPARATUS, ELECTRONIC DEVICE, AND CONTROL METHOD FOR HIGH GRAYSCALE REGION DISPLAY

(71) Applicant: HKC CORPORATION LIMITED, Shenzhen (CN)

(72) Inventors: Peidi HUANG, Shenzhen (CN); Baohong KANG, Shenzhen (CN)

(21) Appl. No.: 19/343,231

(22) Filed: Sep. 29, 2025

Related U.S. Application Data
(63) Continuation of application No. PCT/CN2023/114943, filed on Aug. 25, 2023.

(30) Foreign Application Priority Data
Apr. 10, 2023 (CN) 202310371872.8

(51) Int. Cl. G09G 3/34; G02F 1/13357; G02F 1/1362; G09G 3/20; G09G 3/36

(52) U.S. Cl. CPC G09G 3/3406; G02F 1/136286; G09G 3/2096; G09G 3/3607; G02F 1/133602; G02F 2203/30; G09G 2320/0233; G09G 2320/0626

(57) ABSTRACT

A liquid crystal display apparatus, an electronic device, and a control method for high grayscale region display are provided. The liquid crystal display apparatus includes a liquid crystal panel, a light board, a driving board, a timing controller, and an algorithm controller. The timing controller is configured to store grayscale data of a next-frame display image in a peripheral region. The algorithm controller is configured to read the stored grayscale data and compare a grayscale value of the grayscale data with a preset grayscale value. When a grayscale value of grayscale data corresponding to at least part of the peripheral region is greater than the preset grayscale value, the controller algorithm is configured to determine the high grayscale region and control the driving board to increase a backlight brightness corresponding to the high grayscale region.

This application is a continuation of International Application No. PCT/CN2023/114943, filed Aug. 25, 2023, which claims priority to Chinese Patent Application No. 202310371872.8, filed Apr. 10, 2023, the entire disclosures of which are incorporated herein by reference.

### TECHNICAL FIELD

The present disclosure relates to the field of display apparatus technology, in particular, to a liquid crystal display apparatus, an electronic device, and a control method for high grayscale region display.

### BACKGROUND

With the continuous development of the display industry, various technologies and techniques for improving display effects emerge in an endless stream. Mini light-emitting diode (Mini LED) display technology finds wide application in the market due to higher resolution, higher contrast, wide color gamut range and other characteristics.

However, the design characteristics of the Mini LED bring a problem of edges of the display region being dark when the Mini LED displays high contrast images, which affects the display effect and the quality of Mini LED products.

### SUMMARY

In a first aspect, the disclosure provides a liquid crystal display apparatus. The liquid crystal display apparatus includes a liquid crystal panel, a light board, and a driving board. The liquid crystal panel and the light board are stacked, and the driving board is electrically connected to the light board and is configured to drive the light board to emit light. The liquid crystal panel has a central region and a peripheral region connected to the central region, and the peripheral region surrounds the central region. The liquid crystal display apparatus includes a timing controller and an algorithm controller. The timing controller is electrically connected to the liquid crystal panel, and is configured to store grayscale data of a next-frame display image in the peripheral region of the liquid crystal panel. The algorithm controller is electrically connected to the timing controller, and is configured to read the grayscale data stored in the timing controller and compare a grayscale value of the grayscale data with a preset grayscale value. When a grayscale value of grayscale data corresponding to at least part of a preset region of the peripheral region is greater than the preset grayscale value, the algorithm controller is configured to determine the at least part of the preset region as a high grayscale region, and the algorithm controller is further configured to control the driving board to increase a backlight brightness of the light board corresponding to the high grayscale region, to make a difference in display brightness of the liquid crystal panel between the high grayscale region and the central region less than or equal to 5%.

In a second aspect, the disclosure provides an electronic device, and the electronic device includes the liquid crystal display apparatus in the first aspect.

In a third aspect, the disclosure further provides a control method for high grayscale region display. The control method for high grayscale region display includes the following. A high grayscale data of a next-frame display image in a peripheral region of a liquid crystal panel is determined. A high grayscale region is detected according to the high grayscale data. A backlight brightness corresponding to the high grayscale region is increased to make a difference in display brightness between the high grayscale region and a central region of the liquid crystal panel less than or equal to 5%.

### BRIEF DESCRIPTION OF THE DRAWINGS

In order to describe technical solutions in embodiments of the disclosure more clearly, the following will give a brief introduction to the accompanying drawings required for describing the embodiments. Apparently, the accompanying drawings hereinafter described are merely some embodiments of the disclosure. Based on these drawings, those of ordinary skill in the art can also obtain other drawings without creative effort.

FIG. 1 is a schematic structural view of a liquid crystal display apparatus provided in an embodiment of the disclosure.

FIG. 2 is a schematic three-dimensional exploded view of the liquid crystal display apparatus in FIG. 1.

FIG. 3 is a cross-sectional schematic structural view of the liquid crystal display apparatus in FIG. 1, taken along line A-A.

FIG. 4 is a schematic view illustrating partition of the liquid crystal display apparatus in FIG. 1.

FIG. 5 is a diagram illustrating electronic connection of the liquid crystal display apparatus in FIG. 1.

FIG. 6 is a flow chart of a method for determining high grayscale data provide in an embodiment of the disclosure.

FIG. 7 is a schematic view illustrating partition of a peripheral region in FIG. 4.

FIG. 8 is a flow chart of a method for detecting a high grayscale region provided in an embodiment of the disclosure.

FIG. 9 is a schematic view illustrating distribution of sub-pixels in FIG. 7.

FIG. 10 is a flow chart of a method for detecting a high grayscale region provided in an embodiment of the disclosure.

FIG. 11 is a flow chart of a method for setting backlight-voltage pairs and eliminating a problem of high grayscale region being dark provided in an embodiment of the disclosure.

FIG. 12 is a schematic structural view of an electronic device provided in an embodiment of the disclosure.

Reference signs: electronic device 1; liquid crystal display apparatus 10; liquid crystal panel 11; central region 111; peripheral region 112; sub-region 1121; data line 113; scan line 114; sub-pixel 115; light board 12; driving board 13; timing controller 14; algorithm controller 15.

### DETAILED DESCRIPTION

The following will illustrate technical solutions of embodiments of the disclosure clearly and comprehensively, with reference to the accompanying drawings of embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The terms such as “first” and “second” and the like in the specification, claims, and the accompanying drawings of the disclosure are used for distinguishing between different objects rather than describing a particular order. In addition, the terms “include”, “comprise”, or any other variant thereof, are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

Reference to “embodiment” or “implementation” herein means that a particular feature, structure, or characteristic described in conjunction with the embodiment or implementation may be included in at least one embodiment of the present disclosure. The presence of the term at each place in the specification does not necessarily refer to the same embodiment, nor does it refer to a separate or alternative embodiment that is mutually exclusive of other embodiments. It may be understood by those skilled in the art, both explicitly and implicitly, that the embodiments described herein may be combined with other embodiments.

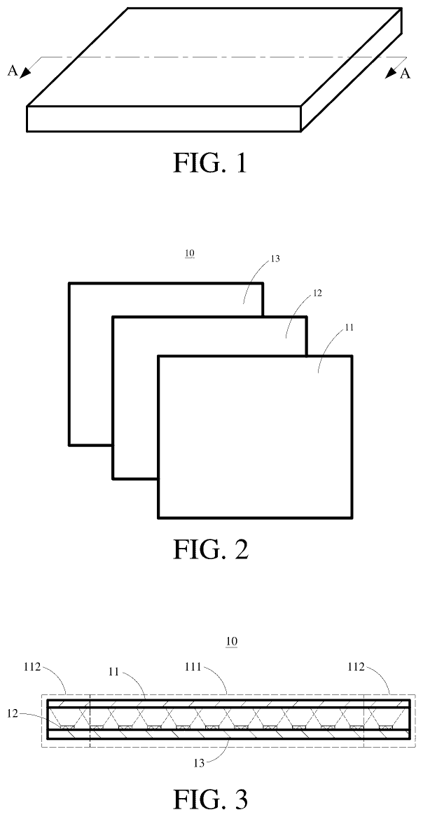

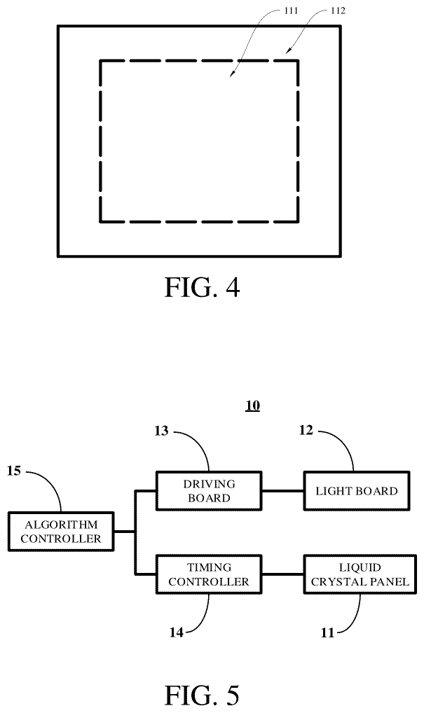

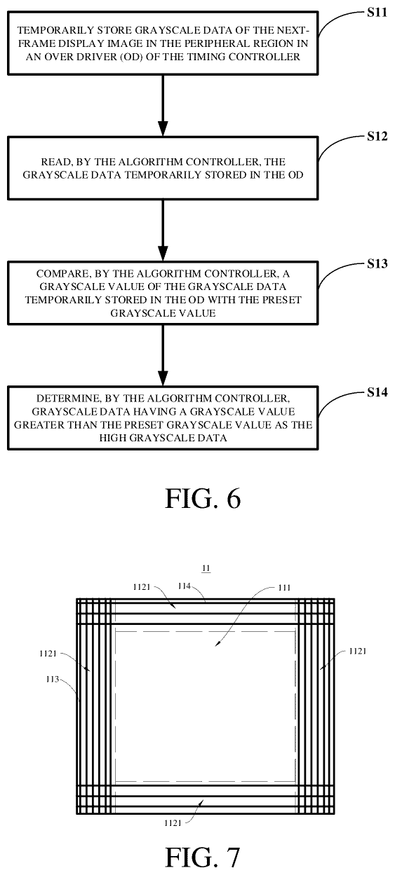

The disclosure provides a liquid crystal display apparatus 10. Reference is made to FIG. 1 to FIG. 6. FIG. 1 is a schematic structural view of a liquid crystal display apparatus provided in an embodiment of the disclosure. FIG. 2 is a schematic three-dimensional exploded view of the liquid crystal display apparatus in FIG. 1. FIG. 3 is a cross-sectional schematic structural view of the liquid crystal display apparatus in FIG. 1, taken along line A-A. FIG. 4 is a schematic view illustrating partition of the liquid crystal display apparatus in FIG. 1. FIG. 5 is a diagram illustrating electronic connection of the liquid crystal display apparatus in FIG. 1. FIG. 6 is a flow chart of determining high grayscale provide in an embodiment of the disclosure. In the embodiment, the liquid crystal display apparatus 10 includes a liquid crystal panel 11, a light board 12, and a driving panel 13 (LED driver). The liquid crystal panel 11 and the light board 12 are stacked, and the driving board 13 is electrically connected to the light board 12 and is configured to drive the light board 12 to emit light. The liquid crystal panel 11 has a central region 111 and a peripheral region 112 connected to the central region 111, and the peripheral region 112 surrounds the central region 111. The liquid crystal display apparatus 10 includes a timing controller 14 (TCON) and an algorithm controller 15. The timing controller 14 is electrically connected to the liquid crystal panel 11, and is configured to store grayscale data of a next-frame display image in the peripheral region 112 of the liquid crystal panel 11. The algorithm controller 15 is electrically connected to the timing controller 14, and is configured to read the grayscale data stored in the timing controller 14 and compare a grayscale value of the grayscale data with a preset grayscale value. When a grayscale value of grayscale data corresponding to at least part of a preset region of the peripheral region 112 is greater than the preset grayscale value, the algorithm controller 15 is configured to determine the at least part of the preset region as a high grayscale region, and the algorithm controller 15 is further configured to control the driving board 13 to increase a backlight brightness of the light board 12 corresponding to the high grayscale region, to make a difference in display brightness of the liquid crystal panel 11 between the high grayscale region and the central region 111 less than or equal to 5%.

In the embodiment, the liquid crystal display apparatus 10 may be applied in various display apparatus, such as a mobile phone, a tablet, a laptop, a palmtop, a personal computer (PC), a personal digital assistant (PDA), etc.

In the embodiment, the light board 12 includes a board body and multiple mini light-emitting diodes (Mini LEDs) that are carried by the board body and are arranged at intervals.

When the Mini LED emits light (please refer to FIG. 3), a viewing angle is generally 135°. Therefore, due to the distribution of the Mini LEDs, in the central region 111, the light emitted by two adjacent Mini LEDs overlaps. However, in the peripheral region 112, the light emitted by one Mini LED on a side near an edge does not overlap with other light, leading to fewer light sources in the peripheral region 112 of the liquid crystal panel 11 than the central region 111 of the liquid crystal panel 11. As a result, the display brightness of the liquid crystal panel 11 in the peripheral region 112 is lower than the display brightness of the liquid crystal panel 11 in the central region 111. When the image displayed in the peripheral region 112 is of high grayscale, an image on the peripheral region 112 darker than an image in the central region 111 is easily observed by human eyes, which may affect users' viewing experience.

In the related art, a light strip is additionally arranged around the Mini LEDs in the peripheral region 112 to increase the display brightness of the liquid crystal panel 11 in the peripheral region 112. However, the light strip additionally arranged not only increases the cost but also causes the temperature in the peripheral region 112 to be too high, thereby affecting the working stability of the liquid crystal display apparatus 10.

Compared with the related art, the liquid crystal display apparatus 10 provided in the disclosure can determine, through the algorithm controller 15, whether there is a high grayscale region in the peripheral region 112 for the next-frame display image. When the algorithm controller 15 determines that at least part of the peripheral region 112 is a high grayscale region, the algorithm controller 15 controls the driving board 13 to increase the backlight brightness of the light board 12 corresponding to the high grayscale region, to make the difference in display brightness of the liquid crystal panel 11 between the high grayscale region and the central region 111 less than or equal to 5%. In this way, a problem of edges in the peripheral region 112 of the liquid crystal panel 11 being dark may be solved, thereby improving the display effect and the quality of the liquid crystal display apparatus 10. Moreover, the cost is low and there is no overheating in the peripheral region 112. In addition, since the algorithm controller 15 determines a region in the peripheral region 112 as the high grayscale region according to the grayscale data of the next-frame display image in the peripheral region 112 stored by the timing controller 14, the backlight brightness corresponding to the high grayscale region is determined in advance, thereby avoiding a problem of edges of the liquid crystal panel 11 being dark during display of every frame of images. Moreover, the algorithm controller 15 firstly determines the high grayscale region in the peripheral region 112, and then adjusts the high grayscale region to make the difference in display brightness of the liquid crystal panel 11 between the high grayscale region and the central region 111 less than or equal to 5%, thereby achieving the effect of accurate correction.

Specifically, a method for determining high grayscale data includes operations at S11, S12, S13, and S14.

At S11, grayscale data of the next-frame display image in the peripheral region is temporarily stored in an over driver (OD) of the timing controller.

At S12, the grayscale data temporarily stored in the OD is read by the algorithm controller.

At S13, a grayscale value of the grayscale data temporarily stored in the OD is compared with the preset grayscale value by the algorithm controller.

At S14, grayscale data having a grayscale value greater than the preset grayscale value is determined as the high grayscale data by the algorithm controller.

The difference in display brightness of the liquid crystal panel 11 between the high grayscale region and the central region 111 is less than or equal to 5%. Specifically, the display brightness of the liquid crystal panel 11 corresponding to the high grayscale region is a first brightness, the brightness of the liquid crystal panel 11 in the central region 111 is a second brightness, and an absolute value of the first brightness minus the second brightness divided by the second brightness is less than or equal to 5%.

In an embodiment, the at least part of the preset region can be, but is not limited to, a single-sided region, multiple-sided regions, part of the single-sided region, or one or more of four-corner regions in the peripheral region 112. It may be understood that, a smaller area of the at least part of the preset region corresponds to a higher accuracy of determining and correcting the high grayscale region in the peripheral region 112, which is set according to the actual application scenario of the liquid crystal display apparatus 10 and working requirements of the liquid crystal display apparatus 10, etc.

In an embodiment, the grayscale value of the grayscale data corresponding to the at least part of the peripheral region 112 greater than the preset grayscale value means that an average grayscale value of all the grayscale data corresponding to the at least part of the peripheral region 112 is greater than the preset grayscale value, or all the grayscale values of all the grayscale data are greater than the preset grayscale value, etc.

In an embodiment, 256 levels of grayscales are taken for example. The preset grayscale value can be, but is not limited to, 200, 210, 220, 190, 180, etc. The preset grayscale value can be less than 180.

In conclusion, the disclosure provides the liquid crystal display apparatus 10. The timing controller 14 of the liquid crystal display apparatus 10 is configured to store the grayscale data of the next-frame display image in the peripheral region 112 of the liquid crystal panel 11. The algorithm controller 15 is configured to read the grayscale data stored in the timing controller 14 and compare the grayscale value of the grayscale data with the preset grayscale value. When the grayscale value of the grayscale data corresponding to the at least part of the peripheral region 112 is greater than the preset grayscale value, the algorithm controller 15 is configured to determine the at least part of the preset region as the high grayscale region, and the algorithm controller 15 is further configured to control the driving board 13 to increase the backlight brightness of the light board 12 corresponding to the high grayscale region, to make the difference in display brightness of the liquid crystal panel 11 between the high grayscale region and the central region 111 less than or equal to 5%. In this way, the problem of edges in the peripheral region 112 of the liquid crystal panel 11 being dark may be solved, thereby improving the display effect and the quality of the liquid crystal display apparatus 10. In addition, since the algorithm controller 15 determines the grayscale data of the next-frame display image before the liquid crystal panel 11 displays the next-frame display image, the backlight brightness corresponding to the high grayscale region is determined in advance, thereby avoiding the problem of edges of the liquid crystal panel 11 being dark during display of every frame of images. Moreover, the algorithm controller 15 firstly determines the high grayscale region in the peripheral region 112, and then adjusts the high grayscale region, thereby achieving the effect of accurate correction. Therefore, the liquid crystal display apparatus 10 provided in the disclosure can improve a problem of dark edges existing in a Mini LED backlight product, without increasing the cost of the product.

Reference is again made to FIG. 5. In the embodiment, the algorithm controller 15 is configured to control the driving board 13 to increase the backlight brightness of the light board 12 corresponding to the high grayscale region and control the timing controller 14 to reduce a control voltage of liquid crystal deflection of the liquid crystal panel 11 in the high grayscale region, to make the display brightness of the liquid crystal panel 11 in the high grayscale region consistent with the display brightness of the liquid crystal panel 11 in the central region 111.

In the embodiment, for the high grayscale region, the algorithm controller 15 is configured to control the driving board 13 to increase the backlight brightness of the light board 12 corresponding to the high grayscale region and control the timing controller 14 to reduce the control voltage of the liquid crystal deflection of the liquid crystal panel 11 in the high grayscale region.

In an embodiment, the algorithm controller 15 is configured to firstly control the driving board 13 to increase the backlight brightness of the light board 12 corresponding to the high grayscale region, and then control the timing controller 14 to reduce the control voltage of liquid crystal deflection of the liquid crystal panel 11 in the high grayscale region. Alternatively, the algorithm controller 15 is configured to firstly control the timing controller 14 to reduce the control voltage of liquid crystal deflection of the liquid crystal panel 11 in the high grayscale region, and then control the driving board 13 to increase the backlight brightness of the light board 12 corresponding to the high grayscale region. Alternatively, the algorithm controller 15 is configured to simultaneously control the driving board 13 and the timing controller 14, as long as the display brightness of the liquid crystal panel 11 in the high grayscale region is consistent with the display brightness of the liquid crystal panel 11 in the central region 111. In the embodiment, an example in which the algorithm controller 15 is configured to firstly control the driving board 13, and then control the timing controller 14 is made.

In the embodiment, after the high grayscale region is determined by the algorithm controller 15, that is, edges are determined to be dark by the algorithm controller 15, the algorithm controller 15 firstly controls the driving board 13 to increase the backlight brightness of the light board 12 corresponding to the high grayscale region, to make the display brightness of the liquid crystal panel 11 in the high grayscale region higher than the display brightness of the liquid crystal panel 11 in the central region 111. Then, the algorithm controller 15 controls the timing controller 14 to reduce the control voltage of liquid crystal deflection of the liquid crystal panel 11 in the high grayscale region, to make the display brightness of the liquid crystal panel 11 in the high grayscale region consistent with the display brightness of the liquid crystal panel 11 in the central region 111. Since the precision of the timing controller 14 controlling the control voltage of liquid crystal deflection of the liquid crystal panel 11 is higher than the precision of the driving board 13 controlling the light board 12, a more accurate adjustment of the display brightness of the high grayscale region can be achieved by firstly increasing the backlight brightness corresponding to the high grayscale region and then reducing the control voltage of liquid crystal deflection. In this way, the display brightness of the high grayscale region is consistent with the display brightness of the central region 111. The control voltage refers to the voltage between a pixel electrode and a common electrode in the liquid crystal panel 11. By adjusting the control voltage, the angle of liquid crystal deflection of the liquid crystal panel 11 can be adjusted. Specifically, the larger the control voltage, the larger the angle of liquid crystal deflection, and the brighter the display brightness of the liquid crystal panel 11. Typically, there is a maximum threshold for the angle of liquid crystal deflection. After the angle of liquid crystal deflection reaches the maximum threshold, the angle of liquid crystal deflection will not be increased by increasing the control voltage. Similarly, the smaller the control voltage, the smaller the angle of liquid crystal deflection, and the darker the display brightness of the liquid crystal panel 11. After the angle of liquid crystal deflection reaches a minimum threshold, the liquid crystal panel 11 no longer emits light.

For example, in the current display technology, the brightness of the light emitted by the light board 12 after passing through the liquid crystal panel 11 is about 5% of the backlight brightness. In this case, 5% is used for illustrative purposes. If an overall backlight brightness of the liquid crystal display apparatus 10 is 10000 nit, the actual display brightness of the central region 111 that human eyes can see is 500 nit, and the display brightness of the high grayscale region in the peripheral region 112 is 450 nit. If the peripheral region 112 includes a high grayscale region during display of the next-frame display image, the high grayscale region in the peripheral region 112 is observed to be dark. After the high grayscale region in the peripheral region 112 is determined by the algorithm controller 15, the algorithm controller 15 controls the driving board 13 to increase the backlight brightness of the light board 12 corresponding to the high grayscale region. For example, the backlight brightness is increased to 12000 nit. In this case, the display brightness of the high grayscale region observed by human eyes is 550 nit. Then, the algorithm controller 15 controls the timing controller 14 to reduce the voltage between the pixel electrode and the common electrode in the liquid crystal panel 11 corresponding to the high grayscale region. That is, the angle of liquid crystal deflection in the high grayscale region is reduced to make the display brightness of the high grayscale region as 500 nit. In this way, the display brightness of the high grayscale region is consistent with the display brightness of the central region 111, thereby improving the display effect of the liquid crystal display apparatus 10. It is to be noted that the above data is for illustrative purposes only and does not limit the backlight brightness and display brightness in the disclosure.

Further, the light board 12 includes multiple control modules, each of the multiple control modules is arranged corresponding to a control region to adjust a backlight brightness of the control region, and different control modules correspond to different control regions, where a sum of all the control regions is a sum of the central region 111 and the peripheral region 112. When the high grayscale region is determined by the algorithm controller 15 and a non-overlapping region exists between the high grayscale region and one or more control regions, the algorithm controller 15 is configured to control the driving board 13 to increase the backlight brightness of the light board 12 corresponding to the high grayscale region (the one or more control regions where the high grayscale region is located), control the timing controller 14 to reduce a control voltage of liquid crystal deflection of the liquid crystal panel 11 in the high grayscale region, and control the timing controller 14 to reduce the control voltage of liquid crystal deflection of the liquid crystal panel 11 in the non-overlapping region, to make the liquid crystal panel display a uniform display brightness. In this way, a problem due to modular backlight adjustment of the light board 12 that the backlight brightness of the non-overlapping region increases while the control voltage of liquid crystal deflection does not reduce can be eliminated. As a result, the display brightness of the liquid crystal panel 11 can be more uniform when the high grayscale region exists.

Reference is made to FIG. 7, which is a schematic view illustrating partition of a peripheral region in FIG. 4. In the embodiment, the peripheral region 112 includes four sub-regions 1121 sequentially connected to one another and disposed on different sides of the central region 111, and every two opposite sub-regions 1121 are of a same size. The liquid crystal panel 11 includes multiple data lines 113 (source line) arranged at intervals and multiple scan lines 114 (gate line) arranged at intervals, and an arrangement direction of the multiple data lines 113 intersects with an arrangement direction of the multiple scan lines 114. The number of data lines 113 in two opposite sub-regions 1121 in the arrangement direction of the multiple data lines 113 is 15%~20% of the number of the multiple data lines 113. The number of scan lines 114 in two opposite sub-regions 1121 in the arrangement direction of the multiple scan lines 114 is 25%~35% of the number of the multiple scan lines 114. It is to be noted that, only a part of the multiple data lines 113 and the multiple scan lines 114 are illustrated in FIG. 7, and for the convenience of illustration, not all the data lines 113 and the scan lines 114 intersecting with each other are illustrated.

In the embodiment, the arrangement direction of the multiple data lines 113 intersects with the arrangement direction of the multiple scan lines 114, and the data line 113 and the scan line 114 is insulated at each intersection, so as to prevent electrical signal interference between the data line 113 and the scan line 114.

In an embodiment, the arrangement direction of the multiple data lines 113 is perpendicular to the arrangement direction of the multiple scan lines 114, or the arrangement direction of the multiple data lines 113 and the arrangement direction of the multiple scan lines 114 are arranged at an included angle (not equals to 90°).

In the embodiment, the number of data lines 113 in two opposite sub-regions 1121 in the arrangement direction of the multiple data lines 113 is 15%~20% of the number of the multiple data lines 113, which is beneficial for performing high grayscale detection to eliminate dark edges on two opposite sub-regions 1121 in the arrangement direction of the multiple data lines 113, and cost-effective. For example, the number of data lines 113 in two opposite sub-regions 1121 in the arrangement direction of the multiple data lines 113 can be 15%, 16%, 17%, 18%, 19%, 20%, or other values between 15%~20%, of the number of the multiple data lines 113. If the number of data lines 113 in two opposite sub-regions 1121 in the arrangement direction of the multiple data lines 113 is less than 15% of the number of the multiple data lines 113, the sub-region 1121 may be too narrow, resulting in regions with dark edges not being detected. If the number of data lines 113 in two opposite sub-regions 1121 in the arrangement direction of the multiple data lines 113 is greater than 20% of the number of the multiple data lines 113, area of regions that need to be detected may be too large, resulting in high detection cost. In addition, some regions away from edges of the liquid crystal panel 11 will not be dark even in high grayscale condition, and the detection cost may be wasted. Therefore, the number of data lines 113 in two opposite sub-regions 1121 in the arrangement direction of the multiple data lines 113 is 15%~20% of the number of the multiple data lines 113, which is beneficial for performing high grayscale detection on two opposite sub-regions 1121 in the arrangement direction of the multiple data lines 113 to eliminate dark edges, and cost-effective.

In the embodiment, the number of scan lines 114 in two opposite sub-regions 1121 in the arrangement direction of the multiple scan lines 114 is 25%~35% of the number of the multiple scan lines 114, which is beneficial for performing high grayscale detection to eliminate dark edges on two opposite sub-regions 1121 in the arrangement direction of the multiple scan lines 114, and cost-effective. For example, the number of scan lines 114 in two opposite sub-regions 1121 in the arrangement direction of the multiple scan lines 114 can be 25%, 27%, 29%, 31%, 33%, 35%, or other values between 25%~35%, of the number of the multiple scan lines 114. If the number of scan lines 114 in two opposite sub-regions 1121 in the arrangement direction of the multiple scan lines 114 is less than 25% of the number of the multiple scan lines 114, the sub-region 1121 may be too narrow, resulting in regions with dark edges not being detected. If the number of scan lines 114 in two opposite sub-regions 1121 in the arrangement direction of the multiple scan lines 114 is greater than 35% of the number of the multiple scan lines 114, area of regions that need to be detected may be too large, resulting in high detection cost. In addition, some regions away from edges of the liquid crystal panel 11 will not be dark even in high grayscale condition, and the detection cost may be wasted. Therefore, the number of scan lines 114 in two opposite sub-regions 1121 in the arrangement direction of the multiple scan lines 114 is 25%~35% of the number of the multiple scan lines 114, which is beneficial for performing high grayscale detection on two opposite sub-regions 1121 in the arrangement direction of the multiple scan lines 114 to eliminate dark edges, and cost-effective.

Exemplarily, a full high definition (FHD) resolution product is taken as an example. The liquid crystal panel 11 has a resolution of 1920*1080, a size of 27-inch, 6600 data lines 113, and 1125 scan lines 114. A region where the 0~500th data lines 113 on the left of the liquid crystal panel 11 are located can be selected as a sub-region 1121. A region where the 6100~6599th data lines 113 on the right of the liquid crystal panel 11 are located can be selected as a sub-region 1121. A region where the 0~200th scan lines 114 on the top of the liquid crystal panel 11 are located can be selected as a sub-region 1121. A region where the 925~1125th scan lines 114 on the bottom of the liquid crystal panel 11 are located can be selected as a sub-region 1121.

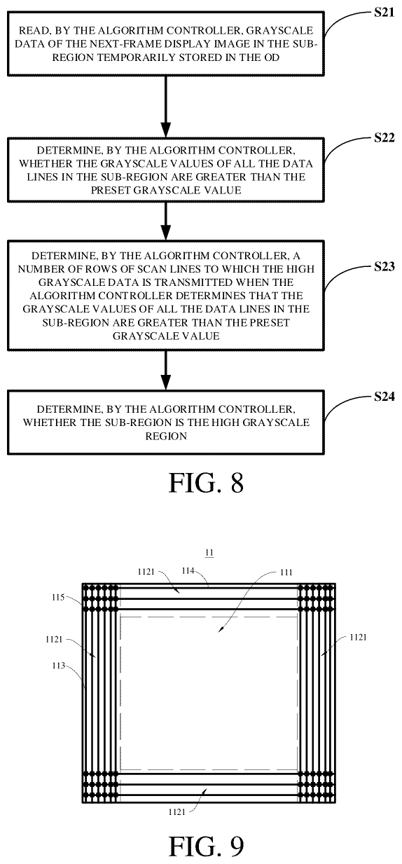

Reference is made to FIG. 5, FIG. 7, and FIG. 8. FIG. 8 is a flow chart of a method for detecting a high grayscale region provided in an embodiment of the disclosure. In the embodiment, the timing controller 14 is configured to store grayscale values of grayscale data of the next-frame display image in all data lines 113 in each sub-region 1121 as first data-grayscale values, and the timing controller 14 is further configured to store grayscale values of grayscale data of the next-frame display image in all scan lines 114 in each sub-region 1121 as first scan-grayscale values. The algorithm controller 15 is configured to read the first data-grayscale values stored by the timing controller 14. When an average value of all the first data-grayscale values in a sub-region 1121 is greater than the preset grayscale value, the algorithm controller 15 is configured to compare an average value of all the first scan-grayscale values in the sub-region 1121 with the preset grayscale value. When the average value of all the first scan-grayscale values in the sub-region 1121 is greater than the preset grayscale value, the algorithm controller 15 is configured to determine the sub-region 1121 as the high grayscale region.

In the embodiment, for each sub-region 1121, the algorithm controller 15 is configured to read the first data-grayscale values and the first scan-grayscale values stored in the timing controller 14, and compare all the first data-grayscale values in the sub-region 1121 with the preset grayscale value, and compare all the first scan-grayscale values in the sub-region 1121 with the preset grayscale value. When the algorithm controller 15 determines that both the average value of all the first data-grayscale values in the sub-region 1121 and the average value of all the first scan-grayscale values in the sub-region 1121 are greater than the preset grayscale value, the algorithm controller 15 is configured to determine the sub-region 1121 as the high grayscale region. In the embodiment, the high grayscale region can be accurately detected, and all the sub-regions 1121 can be covered.

In an embodiment of the disclosure, the method for detecting the high grayscale region includes operations at S21, S22, S23, and S24.

At S21, grayscale data of the next-frame display image in the sub-region temporarily stored in the OD is read by the algorithm controller.

At S22, whether an average value of the grayscale values of all the data lines in the sub-region are greater than the preset grayscale value is determined by the algorithm controller.

At S23, when the algorithm controller determines that the average value of the grayscale values of all the data lines in the sub-region are greater than the preset grayscale value, a number of rows of scan lines to which the high grayscale data is transmitted is determined by the algorithm controller.

At S24, whether the sub-region is the high grayscale region is determined by the algorithm controller.

Specifically, for example, the four sub-regions 1121 can be region X1, region X2,region X3, and region X4, respectively. The region X1 is taken as an example. The region X1 is a sub-region 1121 on the left of the liquid crystal display apparatus 10 in the arrangement direction of the multiple data lines 113. After the grayscale data of the next-frame display image in the region X1 is stored in the OD of the timing controller 14, the algorithm controller 15 collects the grayscale data stored in the OD, where the grayscale data includes the first data-grayscale values and the first scan-grayscale values. The algorithm controller 15 firstly analyzes all the first data-grayscale values in the region X1. When the average value of all the first data-grayscale values is greater than the preset grayscale value, the timing controller 14 determines the first data-grayscale values corresponding to the data lines 113 in the region X1 are high grayscale values, which are defined as gray=1. Then, the algorithm controller 15 determines the number of rows of scan lines to which the grayscale data of all the scan lines 114 in the region X1 is transmitted during the display of the next-frame display image. That is, the algorithm controller 15 determines the number of high grayscale values among the first scan-grayscale values corresponding to the scan lines 114 in the region X1. When the average value of all the first scan-grayscale values is greater than the preset grayscale value, the region X1 is defined as V1, which means the region X1 is the high grayscale region. In this case, dark edges exist. Similarly, the region X2, the region X3, and the region X4 can be determined in the same manner as the region X1.

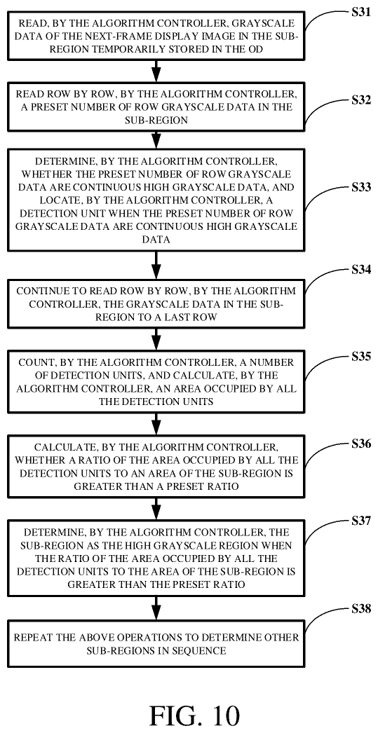

Reference is made to FIG. 5, FIG. 7, FIG. 9, and FIG. 10. FIG. 9 is a schematic view illustrating distribution of sub-pixels in FIG. 7. FIG. 10 is a flow chart of a method for detecting a high grayscale region provided in an embodiment of the disclosure. In the embodiment, a sub-pixel 115 is correspondingly disposed at an intersection of each data line 113 and each scan line 114. The timing controller 14 is configured to store grayscale values of grayscale data of the next-frame display image in all the data lines 113 in the sub-region 1121 as second data-grayscale values, and the timing controller 14 is further configured to store grayscale values of grayscale data of the next-frame display image in all the scan lines 114 in the sub-region 1121 as second scan-grayscale values. For each sub-region 1121, when the algorithm controller 15 determines that the average value of all the first data-grayscale values of the next-frame display image in all the data lines 113 in the sub-region 1121 is less than or equal to the preset grayscale value, and/or the algorithm controller 15 determines that the average value of all the first scan-grayscale values of the next-frame display image in all the scan lines 114 in the sub-region 1121 is less than or equal to the preset grayscale value, the algorithm controller 15 is further configured to, for each sub-pixel 115, determine whether a second data-grayscale value of the next-frame display image in a corresponding data line 113 in the sub-region 1121 and a second scan-grayscale value of the next-frame display image in a corresponding scan line 114 in the sub-region 1121 are both greater than the preset grayscale value, and determine the sub-pixel 115 as a high grayscale pixel when both the second data-grayscale value and the second scan-grayscale value are greater than the preset grayscale value. The algorithm controller 15 is further configured to determine a preset number of consecutive and adjacent high grayscale pixels as a detection unit. When a ratio of an area occupied by all the detection units in the sub-region 1121 to an area of the sub-region 1121 is greater than a preset ratio, the algorithm controller 15 is configured to determine the sub-region 1121 as the high grayscale region. It is to be noted that, only a part of the multiple data lines 113 and the multiple scan lines 114 are illustrated in FIG. 9, and for the convenience of illustration, not all the data lines 113 and the scan lines 114 intersecting with each other are illustrated, that is, not all the sub-pixels 115 in the sub-regions 1121 are illustrated.

A relatively large number of discontinuous high grayscale data may easily lead to the average value of all the first data-grayscale values of the next-frame display image in all the data lines 113 in the sub-region 1121 less than or equal to the preset grayscale value, and/or the average value of all the first scan-grayscale values of the next-frame display image in all the scan lines 114 in the sub-region 1121 less than or equal to the preset grayscale value. In this case, the detection on the high grayscale region in the previous embodiment may become invalid.

In the embodiment, when the algorithm controller 15 determines that the average value of all the first data-grayscale values of the next-frame display image in all the data lines 113 in the sub-region 1121 is less than or equal to the preset grayscale value, and/or the average value of all the first scan-grayscale values of the next-frame display image in all the scan lines 114 in the sub-region 1121 is less than or equal to the preset grayscale value, the timing controller 14 determines the high grayscale region by using the ratio of the area of high grayscale pixels to the area of the sub-region 1121. In this way, the high grayscale region not being detected may be avoided.

In an embodiment, in a case where the previous embodiment determines that there is no high grayscale region, the method for detecting the high grayscale region further includes operations at S31, S32, S33, S34, S35, S36, S37, and S38.

At S31, grayscale data of the next-frame display image in the sub-region temporarily stored in the OD is read by the algorithm controller.

At S32, a preset number of row grayscale data in the sub-region is read row by row by the algorithm controller.

At S33, whether the preset number of row grayscale data are continuous high grayscale data is determined by the algorithm controller, and a detection unit is located by the algorithm controller when the preset number of row grayscale data are continuous high grayscale data.

At S34, the grayscale data in the sub-region is continued to be read row by row by the algorithm controller to a last row.

At S35, a number of detection units is counted and an area occupied by all the detection units is calculated by the algorithm controller.

At S36, whether a ratio of the area occupied by all the detection units to an area of the sub-region is greater than a preset ratio is calculated by the algorithm controller.

At S37, when the ratio of the area occupied by all the detection units to the area of the sub-region is greater than the preset ratio, the sub-region is determined by the algorithm controller as the high grayscale region.

At S38, the above operations are repeated to determine other sub-regions in sequence.

Specifically, for example, the four sub-regions 1121 can be region X1, region X2,region X3, and region X4, respectively. The region X1 is taken as an example. The region X1 is a sub-region 1121 on the left of the liquid crystal display apparatus 10 in the arrangement direction of the multiple data lines 113. After the grayscale data of the next-frame display image in the region X1 is stored in the OD of the timing controller 14, the algorithm controller 15 collects the grayscale data stored in the OD, where the grayscale data includes the second data-grayscale values and the second scan-grayscale values. Since the image of the liquid crystal display apparatus 10 is displayed row by row, the second data-grayscale value and the second scan-grayscale value corresponding to each sub-pixel 115 are read row by row during detection. When both the second data-grayscale value and the second scan-grayscale value corresponding to the sub-pixel 115 are greater than the preset grayscale value, the algorithm controller 15 determines the sub-pixel 115 as the high grayscale pixel, which is marked as gray1=1, and store the gray1=1 to a row storage module (TCON buffer) in the timing controller 14. When the algorithm controller 15 determines that there is a preset number y of high grayscale pixels arranged continuously, the algorithm controller 15 determines gray1~y=1, and determine the high grayscale pixels arranged continuously as a detection unit, which is defined as x1=1. All the detection units in the region X1 are determined according to the above operations, which are marked as M1=x1+x2+. . . +xn. When a ratio of an area occupied by M1 to an area of the region X1 is greater than a preset ratio, the algorithm controller 15 determines the region X1 as the high grayscale region. That is, dark edges exist. Similarly, the region X2, the region X3, and the region X4 can be determined in the same manner as the region X1. It may be understood that, the second data-grayscale value is essentially the same as the first data-grayscale value, and the second scan-grayscale value is essentially the same as the second scan-grayscale value. Different names being given here are solely for the purpose of distinguishing and explaining different detection methods.

In an embodiment, the preset number is less than or equal to a row storage threshold of the TCON buffer, where a larger preset number corresponds to a higher detection accuracy corresponding to each sub-region 1121. A smaller preset number corresponds to a lower detection cost corresponding to each sub-region 1121. The specific preset number can be set according to actual needs, which is not limited herein. For example, the preset number may be, but is not limited to, 10, 8, 6, 4, 12, 14, 16, etc.

In an embodiment, a larger preset ratio corresponds to a more accurate detection of the sub-region 1121. Specifically, the preset ratio can be set according to actual needs, which is not limited herein. For example, the preset ratio may be, but is not limited to, 50%, 60%, 70%, 40%, 30%, etc.

In addition, the algorithm controller 15 is configured to determine high grayscale pixels disposed at intersections between a first number of adjacent and consecutive data lines 113 and a second number of adjacent and consecutive scan lines 114 as the detection unit, where the first number is greater than or equal to 1, the second number is greater than or equal to 1, and a product of the first number and the second number is the preset number. Therefore, the detection unit may be defined according to the model of the liquid crystal display apparatus 10 and actual working conditions of the liquid crystal display apparatus 10, etc., which is beneficial for detecting the sub-region 1121.

Further, in the arrangement direction of the multiple data lines 113, the two opposite sub-regions 1121 each includes a main region and two opposite corner regions, the two opposite corner regions are disposed on opposite sides of the main region, and the two opposite corner regions are connected to the main region. The algorithm controller 15 is configured to determine a first preset number of adjacent and consecutive high grayscale pixels in the main region as a first detection unit. The algorithm controller 15 is configured to determine a second preset number of adjacent and consecutive high grayscale pixels in each of the corner regions as a second detection unit, where the second preset number is less than the first preset number. In this way, the precision of the algorithm controller 15 detecting the corner regions is higher than the precision of the algorithm controller 15 detecting the main region board 13, which is beneficial for detecting the corner regions to deal with a situation where the corner regions are more prone to being dark. In addition, the detection can be more accurate, and the detection cost may be reduced.

In addition, the timing controller 14 may be configured to determine the high grayscale region by directly using the ratio of the area of high grayscale pixels to the area of the sub-region 1121. Reference is again made to FIG. 5, FIG. 7, FIG. 9, and FIG. 10. In the embodiment, a sub-pixel 115 is correspondingly disposed at an intersection of each data line 113 and each scan line 114. The timing controller 14 is configured to store grayscale values of grayscale data of the next-frame display image in all the data lines 113 in the sub-region 1121 as second data-grayscale values, and the timing controller 14 is configured to store grayscale values of grayscale data of the next-frame display image in all the scan lines 114 in the sub-region 1121 as second scan-grayscale values. For each sub-region 1121, the algorithm controller 15 is configured to, for each sub-pixel 115, determine whether a second data-grayscale values of the next-frame display image in a corresponding data line 113 in the sub-region 1121 and a second scan-grayscale values of the next-frame display image in a corresponding scan line 114 in the sub-region 1121 are both greater than the preset grayscale value, and determine the sub-pixel 115 as a high grayscale pixel when both the second data-grayscale value and the second scan-grayscale value are greater than the preset grayscale value. The algorithm controller 15 is further configured to determine a preset number of consecutive and adjacent high grayscale pixels as a detection unit. When a ratio of an area occupied by all the detection units in the sub-region 1121 to an area of the sub-region is greater than a preset ratio, the algorithm controller 15 is configured to determine the sub-region as the high grayscale region.

In the embodiment, the timing controller 14 is configured to determine the high grayscale region by directly using the ratio of the area of high grayscale pixels to the area of the sub-region 1121, which is the same as the previous embodiment, where the timing controller 14 is configured to determine the high grayscale region by using the ratio of the area of high grayscale pixels to the area of the sub-region 1121. Therefore, the technical solution will not be repeated herein.

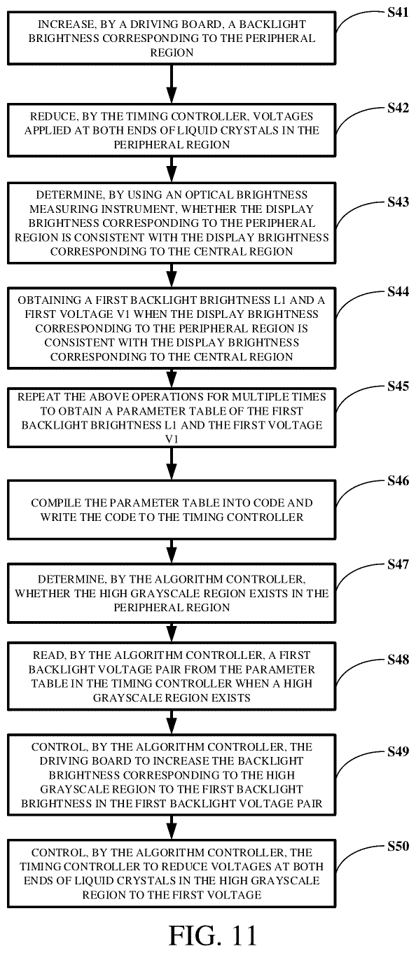

Reference is made to FIG. 4, FIG. 5, and FIG. 11. FIG. 11 is a flow chart of a method for setting backlight-voltage pairs and eliminating a problem of high grayscale region being dark provided in an embodiment of the disclosure. In the embodiment, a brightness of the light board 12 corresponding to the peripheral region 112 is a first backlight brightness, and a control voltage of liquid crystal deflection of the liquid crystal panel 11 in the peripheral region 112 is a first voltage. The timing controller 14 is configured to store multiple first backlight-voltage pairs. When the light board 12 and the liquid crystal panel 11 are controller by different first backlight-voltage pairs, a display brightness of the peripheral region 112 is consistent with a display brightness of the central region 111. Different first backlight-voltage pairs correspond to a same display brightness of the central region 111. The first backlight-voltage pairs each includes a first backlight brightness and a first voltage, and different first backlight-voltage pairs have different first backlight brightness and different first voltages. When the high grayscale region is determined by the algorithm controller 15, the algorithm controller 15 is configured to read one of the multiple first backlight-voltage pairs, control the driving board 13 to adjust the backlight brightness of the light board 12 corresponding to the high grayscale region to the first backlight brightness of the first backlight-voltage pair, and control the timing controller 14 to adjust the control voltage of liquid crystal deflection of the liquid crystal panel 11 in the high grayscale region to the first voltage of the first backlight-voltage pair.

In the embodiment, for a certain display brightness of the liquid crystal panel 11 in the central region 111, multiple first backlight-voltage pairs are stored in the timing controller 14 in advance. In a case where different first backlight-voltage pairs are used to control the light board 12 and the liquid crystal panel 11, the display brightness of the peripheral region 112 is consistent with the display brightness of the central region 111.

In the embodiment, a method for setting the first backlight-voltage pairs and eliminating the problem of high grayscale region being dark includes operations at S41~S50.

At S41, a backlight brightness corresponding to the peripheral region is increased by a driving board.

At S42, voltages applied at both ends of liquid crystals in the peripheral region are reduced by the timing controller.

At S43, whether the display brightness of the peripheral region is consistent with the display brightness of the central region is determined by using an optical brightness measuring instrument.

At S44, when the display brightness of the peripheral region is consistent with the display brightness of the central region, a first backlight brightness L1 and a first voltage V1 are obtained.

At S45, the above operations are repeated for multiple times to obtain a parameter table of multiple first backlight brightness L1 and multiple first voltages V1.

At S46, the parameter table is compiled into code to be written into the timing controller.

At S47, whether the high grayscale region exists in the peripheral region is determined by the algorithm controller.

At S48, when a high grayscale region exists, a first backlight-voltage pair from the parameter table in the timing controller is read by the algorithm controller.

At S49, the driving board is controlled by the algorithm controller to increase the backlight brightness corresponding to the high grayscale region to the first backlight brightness in the first backlight-voltage pair.

At S50, the timing controller is controlled by the algorithm controller to reduce voltages at both ends of liquid crystals in the high grayscale region to the first voltage.

Specifically, during design, for the peripheral region 112 and the central region 111, when display brightness of the central region 111 is fixed, the backlight brightness corresponding to the peripheral region 112 is gradually increased and the voltage at both ends of liquid crystals in the peripheral region 112 is reduced. Whether the display brightness of the peripheral region 112 is consistent with the display brightness of the central region 111 is determined by using an optical brightness measuring instrument. In this way, for each unit of the backlight brightness corresponding to the peripheral region 112 increased, a corresponding control voltage for controlling the liquid crystal deflection in the peripheral region 112 is determined, and thus a parameter table for adjusting the first backlight brightness and corresponding first voltage in the peripheral region 112 is formed. The parameter table is compiled into code to be written into the timing controller 14. A first backlight brightness and a first voltage that can achieve consistent display brightness of both the peripheral region 112 and the central region 111 form a backlight-voltage pair. For example, an initial backlight brightness corresponding to the peripheral region 112 and an initial backlight brightness of the central region 111 are both 10000 nit, and a unit of backlight brightness is set as 100 nit. The backlight brightness corresponding to the peripheral region 112 is gradually increased by 100 nit each time, and a corresponding control voltage for liquid crystal deflection in the peripheral region 112 can be measured using the optical brightness measuring instrument, thereby obtaining multiple backlight-voltage pairs.

In an embodiment, the multiple backlight-voltage pairs can be represented in the form of a parameter table, or a parameter curve formed by fitting.

In the embodiment, the multiple first backlight-voltage pairs are stored in the timing controller 14 in advance. In this way, after the high grayscale region is determined by the algorithm controller 15, one of the multiple first backlight-voltage pairs can be quickly selected to make the display brightness of the high grayscale region consistent with the display brightness of the central region 111, thereby eliminating the problem of edges being dark and achieving high working efficiency.

Further, a brightness of the light board 12 corresponding to the central region 111 is a second backlight brightness, and a control voltage of liquid crystal deflection of the liquid crystal panel 11 in the central region 111 is a second voltage. The timing controller 14 is configured to store multiple second backlight-voltage pairs, where the second backlight-voltage pairs each includes a second backlight brightness and a second voltage, and different second backlight-voltage pairs have different second backlight brightness and different second voltages. Each of the second backlight-voltage pairs correspond to multiple first backlight-voltage pairs, and different second backlight-voltage pairs correspond to different first backlight-voltage pairs. For each second backlight-voltage pair, the display brightness of the peripheral region 112 is consistent with the display brightness of the central region 111 when the light board 12 and the liquid crystal panel 11 are controlled by different first backlight-voltage pairs corresponding to the second backlight-voltage pair. When the high grayscale region is determined by the algorithm controller 15, the algorithm controller 15 is configured to read the current second backlight brightness and second voltage of the central region 111 to obtain a second backlight-voltage pair, and read a first backlight-voltage pair from the multiple first backlight-voltage pairs according to the second backlight-voltage pair. The algorithm controller 15 is configured to control the driving board 13 to adjust the backlight brightness of the light board 12 corresponding to the high grayscale region to the first backlight brightness of the first backlight-voltage pair, and control the timing controller 14 to adjust the control voltage of liquid crystal deflection of the liquid crystal panel 11 in the high grayscale region to the first voltage of the first backlight-voltage pair.

In the embodiment, the display brightness of the liquid crystal panel 11 in the central region 111 will change, and the multiple first backlight-voltage pairs and the multiple second backlight-voltage pairs are stored in the timing controller 14 in advance. The display brightness of the central region 111 includes multiple central brightness, each central brightness includes one or more second backlight-voltage pairs, and each second backlight-voltage pair corresponds to the multiple first backlight-voltage pairs. In the embodiment, when the high grayscale region is determined by the algorithm controller 15, the algorithm controller 15 reads the current second backlight brightness and the second voltage in the central region 111 to obtain a second backlight-voltage pair, read the first backlight-voltage pair in the timing controller 14 according to the second backlight-voltage pair, control the driving board 13 to adjust the backlight brightness of the light board 12 corresponding to the high grayscale region to the first backlight brightness of the first backlight-voltage pair, and control the timing controller 14 to adjust the control voltage of liquid crystal deflection of the liquid crystal panel 11 corresponding to the high grayscale region to the first voltage of the first backlight-voltage pair.

In other words, in the embodiment, after the second backlight-voltage pair corresponding to the current display brightness of the liquid crystal panel 11 in the central region 111 is determined by the algorithm controller 15, the subsequent control operation is the same as the previous embodiment. In this way, the problem of edges being dark can be quickly eliminated after the high grayscale region is determined, and a high work efficiency can be achieved.

In an embodiment, the changing of the display brightness of the liquid crystal panel 11 in the central region 111 refers to the changing of the display brightness of the liquid crystal display apparatus 10 in the central region 111 according to working conditions, or according to the adjustment of users.

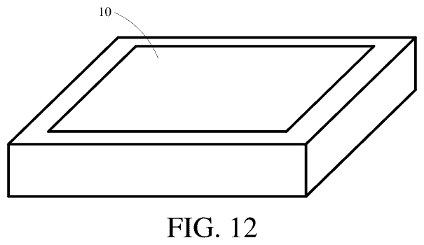

The disclosure further provides an electronic device 1. Reference is made to FIG. 12, which is a schematic structural view of an electronic device provided in an embodiment of the disclosure. In the embodiment, the electronic device 1 includes the liquid crystal display apparatus 10 provided in any above embodiments.

In the embodiment, the electronic device 1 may be, but is not limited to, a mobile phone, a tablet, a laptop, a palmtop, a PC, a PDA, etc.

In the embodiment, in the electronic device 1, the liquid crystal display apparatus 10 can detect the high grayscale region in the peripheral region 112 for the next-frame display image, and adjust the backlight brightness corresponding to the high grayscale region to make the difference in display brightness between the high grayscale region and the central region 111 less than 5%. In this way, the problem of edges of the liquid crystal panel 11 of the electronic device 1 being dark may be eliminated, thereby improving the display effect of the electronic device 1 and improving user experience.

In an embodiment, the electronic device 1 further includes a middle frame, a power supply, and a back cover. One side of the middle frame is used to accommodate the liquid crystal display apparatus 10, and the other side of the middle frame is used to accommodate the power supply. The power supply is electrically connected to the liquid crystal display apparatus 10 for supplying power to the liquid crystal display apparatus 10. The back cover is connected to the middle frame to seal the power supply. Alternatively, the electronic device 1 further includes a power supply and a housing, where the power supply is electrically connected to the liquid crystal display apparatus 10 for supplying power to the liquid crystal display apparatus 10, and the housing is used to accommodate the liquid crystal display apparatus 10 and the power supply. The electronic device 1 may also have other structures different from the above structures, which are not limited herein.

Although the embodiments of the disclosure have been illustrated or described above, it can be understood that the above-mentioned embodiments are exemplary, and should not be understood as limits to the disclosure. Those of ordinary skill in the art may make variations, modifications, replacements, transformations to the abovementioned embodiments within the scope of the disclosure, and improvements and polishing shall also fall within the protection scope of the disclosure.

1. A liquid crystal display apparatus, comprising a liquid crystal panel, a light board, and a driving board, wherein the liquid crystal panel and the light board are stacked, and the driving board is electrically connected to the light board and is configured to drive the light board to emit light; the liquid crystal panel has a central region and a peripheral region connected to the central region, and the peripheral region surrounds the central region; wherein the liquid crystal display apparatus further comprises:
a timing controller, wherein the timing controller is electrically connected to the liquid crystal panel, and is configured to store grayscale data of a next-frame display image in the peripheral region of the liquid crystal panel; and
an algorithm controller, wherein the algorithm controller is electrically connected to the timing controller, and is configured to read the grayscale data stored in the timing controller and compare a grayscale value of the grayscale data with a preset grayscale value; the algorithm controller is configured to determine at least part of a preset region as a high grayscale region in response to a grayscale value of grayscale data corresponding to the at least part of the preset region of the peripheral region being greater than the preset grayscale value; and the algorithm controller is further configured to control the driving board to increase a backlight brightness of the light board corresponding to the high grayscale region, to make a difference in display brightness of the liquid crystal panel between the high grayscale region and the central region less than or equal to 5%.

2. The liquid crystal display apparatus of claim 1, wherein the algorithm controller is configured to control the timing controller to reduce a control voltage of liquid crystal deflection of the liquid crystal panel in the high grayscale region, to make the display brightness of the liquid crystal panel in the high grayscale region consistent with the display brightness of the liquid crystal panel in the central region.

3. The liquid crystal display apparatus of claim 2, wherein the algorithm controller is configured to firstly control the driving board to increase the backlight brightness of the light board corresponding to the high grayscale region, and then control the timing controller to reduce the control voltage of liquid crystal deflection of the liquid crystal panel in the high grayscale region, to make the display brightness of the liquid crystal panel in the high grayscale region consistent with the display brightness of the liquid crystal panel in the central region;
or the algorithm controller is configured to firstly control the timing controller to reduce the control voltage of liquid crystal deflection of the liquid crystal panel in the high grayscale region, and then control the driving board to increase the backlight brightness of the light board corresponding to the high grayscale region, to make the display brightness of the liquid crystal panel in the high grayscale region consistent with the display brightness of the liquid crystal panel in the central region;
or the algorithm controller is configured to simultaneously control the driving board and the timing controller, to make the display brightness of the liquid crystal panel in the high grayscale region consistent with the display brightness of the liquid crystal panel in the central region.

4. The liquid crystal display apparatus of claim 2, wherein the light board comprises a plurality of control modules, each of the plurality of control modules is arranged corresponding to a control region to adjust a backlight brightness of the control region, and different control modules correspond to different control regions, wherein a sum of all the control regions is a sum of the central region and the peripheral region.

5. The liquid crystal display apparatus of claim 4, wherein in response to the high grayscale region being determined by the algorithm controller and a non-overlapping region existing between the high grayscale region and one or more control regions, the algorithm controller is configured to control the driving board to increase the backlight brightness of the light board corresponding to the high grayscale region, control the timing controller to reduce the control voltage of liquid crystal deflection of the liquid crystal panel in the high grayscale region, and control the timing controller to reduce a control voltage of liquid crystal deflection of the liquid crystal panel in the non-overlapping region, to make the liquid crystal panel display a uniform display brightness.

6. The liquid crystal display apparatus of claim 1, wherein the peripheral region comprises four sub-regions sequentially connected to one another and disposed on different sides of the central region, and every two opposite sub-regions are of a same size;
the liquid crystal panel comprises a plurality of data lines arranged at intervals and a plurality of scan lines arranged at intervals, and an arrangement direction of the plurality of data lines intersects with an arrangement direction of the plurality of scan lines;
a number of data lines in two opposite sub-regions in the arrangement direction of the plurality of data lines is 15%~20% of a number of the plurality of data lines; and
a number of scan lines in two opposite sub-regions in the arrangement direction of the plurality of scan lines is 25%~35% of a number of the plurality of scan lines.

7. The liquid crystal display apparatus of claim 6, wherein the timing controller is configured to store grayscale values of grayscale data of the next-frame display image in all data lines in each sub-region as first data-grayscale values, and the timing controller is further configured to store grayscale values of grayscale data of the next-frame display image in all scan lines in the sub-region as first scan-grayscale values; and
wherein the algorithm controller is configured to read the first data-grayscale values stored by the timing controller; the algorithm controller is configured to, in response to an average value of all the first data-grayscale values in a sub-region being greater than the preset grayscale value, compare an average value of all the first scan-grayscale values in the sub-region with the preset grayscale value; and the algorithm controller is configured to, in response to the average value of all the first scan-grayscale values in the sub-region being greater than the preset grayscale value, determine the sub-region as the high grayscale region.

8. The liquid crystal display apparatus of claim 7, wherein a sub-pixel is correspondingly disposed at an intersection of each data line and each scan line; the timing controller is configured to store grayscale values of grayscale data of the next-frame display image in all the data lines in the sub-region as second data-grayscale values, and the timing controller is further configured to store grayscale values of grayscale data of the next-frame display image in all the scan lines in the sub-region as second scan-grayscale values;
for each sub-region, in response to the algorithm controller determining that the average value of all the first data-grayscale values of the next-frame display image in all the data lines in the sub-region is less than or equal to the preset grayscale value, and/or the algorithm controller determining that the average value of all the first scan-grayscale values of the next-frame display image in all the scan lines in the sub-region is less than or equal to the preset grayscale value, the algorithm controller is further configured to:
for each sub-pixel, determine whether a second data-grayscale value of the next-frame display image in a corresponding data line in the sub-region and a second scan-grayscale value of the next-frame display image in a corresponding scan line in the sub-region are both greater than the preset grayscale value; and determine the sub-pixel as a high grayscale pixel in response to both the second data-grayscale value and the second scan-grayscale value being greater than the preset grayscale value;
the algorithm controller is further configured to determine a preset number of consecutive and adjacent high grayscale pixels as a detection unit; and the algorithm controller is configured to determine the sub-region as the high grayscale region in response to a ratio of an area occupied by all the detection units in the sub-region to an area of the sub-region being greater than a preset ratio.

9. The liquid crystal display apparatus of claim 8, wherein in the arrangement direction of the plurality of data lines, the two opposite sub-regions each comprises a main region and two opposite corner regions, the two opposite corner regions are disposed on opposite sides of the main region, and the two opposite corner regions are connected to the main region;
the algorithm controller is configured to determine a first preset number of adjacent and consecutive high grayscale pixels in the main region as a first detection unit; and
the algorithm controller is configured to determine a second preset number of adjacent and consecutive high grayscale pixels in each of the corner regions as a second detection unit, wherein the second preset number is less than the first preset number.

10. The liquid crystal display apparatus of claim 6, wherein a sub-pixel is correspondingly disposed at an intersection of each data line and each scan line; the timing controller is configured to store grayscale values of grayscale data of the next-frame display image in all the data lines in the sub-region as second data-grayscale values, and the timing controller is configured to store grayscale values of grayscale data of the next-frame display image in all the scan lines in the sub-region as second scan-grayscale values;
for each sub-region, the algorithm controller is configured to:
for each sub-pixel, determine whether a second data-grayscale value of the next-frame display image in a corresponding data line in the sub-region and a second scan-grayscale value of the next-frame display image in a corresponding scan line in the sub-region are both greater than the preset grayscale value; and determine the sub-pixel as a high grayscale pixel in response to both the second data-grayscale value and the second scan-grayscale value being greater than the preset grayscale value;
the algorithm controller is further configured to determine a preset number of consecutive and adjacent high grayscale pixels as a detection unit; and the algorithm controller is configured to determine the sub-region as the high grayscale region in response to a ratio of an area occupied by all the detection units in the sub-region to an area of the sub-region being greater than a preset ratio.

11. The liquid crystal display apparatus of claim 8, wherein the algorithm controller is configured to determine high grayscale pixels disposed at intersections between a first number of adjacent and consecutive data lines and a second number of adjacent and consecutive scan lines as the detection unit, wherein the first number is greater than or equal to 1, the second number is greater than or equal to 1, and a product of the first number and the second number is the preset number.

12. The liquid crystal display apparatus of claim 2, wherein a brightness of the light board corresponding to the peripheral region is a first backlight brightness, and a control voltage of liquid crystal deflection of the liquid crystal panel in the peripheral region is a first voltage;
the timing controller is configured to store a plurality of first backlight-voltage pairs; in response to different first backlight-voltage pairs controlling the light board and the liquid crystal panel, a display brightness of the peripheral region is consistent with a display brightness of the central region, and different first backlight-voltage pairs correspond to a same display brightness of the central region; wherein the first backlight-voltage pairs each comprises a first backlight brightness and a first voltage, and different first backlight-voltage pairs have different first backlight brightness and different first voltages;
in response to the high grayscale region being determined by the algorithm controller, the algorithm controller is configured to read one of the plurality of first backlight-voltage pairs, control the driving board to adjust the backlight brightness of the light board corresponding to the high grayscale region to the first backlight brightness of the first backlight-voltage pair, and control the timing controller to adjust the control voltage of liquid crystal deflection of the liquid crystal panel in the high grayscale region to the first voltage of the first backlight-voltage pair.

13. The liquid crystal display apparatus of claim 12, wherein a brightness of the light board corresponding to the central region is a second backlight brightness, and a control voltage of liquid crystal deflection of the liquid crystal panel in the central region is a second voltage;
the timing controller is configured to store a plurality of second backlight-voltage pairs, wherein the second backlight-voltage pairs each comprises a second backlight brightness and a second voltage, and different second backlight-voltage pairs have different second backlight brightness and different second voltages; each of the second backlight-voltage pairs correspond to a plurality of first backlight-voltage pairs, and different second backlight-voltage pairs correspond to different first backlight-voltage pairs; for each second backlight-voltage pair, the display brightness of the peripheral region is consistent with the display brightness of the central region in response to the light board and the liquid crystal panel being controlled by different first backlight-voltage pairs of the plurality of first backlight-voltage pairs corresponding to the second backlight-voltage pair;
in response to the high grayscale region being determined by the algorithm controller, the algorithm controller is configured to read the current second backlight brightness and second voltage of the central region to obtain a second backlight-voltage pair, and read a first backlight-voltage pair from the plurality of first backlight-voltage pairs according to the second backlight-voltage pair; and the algorithm controller is configured to control the driving board to adjust the backlight brightness of the light board corresponding to the high grayscale region to the first backlight brightness of the first backlight-voltage pair, and control the timing controller to adjust the control voltage of liquid crystal deflection of the liquid crystal panel in the high grayscale region to the first voltage of the first backlight-voltage pair.

14. An electronic device, comprising a liquid crystal display apparatus, wherein the liquid crystal display apparatus comprises a liquid crystal panel, a light board, and a driving board, wherein the liquid crystal panel and the light board are stacked, and the driving board is electrically connected to the light board and is configured to drive the light board to emit light; the liquid crystal panel has a central region and a peripheral region connected to the central region, and the peripheral region surrounds the central region; wherein the liquid crystal display apparatus further comprises:
a timing controller, wherein the timing controller is electrically connected to the liquid crystal panel, and is configured to store grayscale data of a next-frame display image in the peripheral region of the liquid crystal panel; and
an algorithm controller, wherein the algorithm controller is electrically connected to the timing controller, and is configured to read the grayscale data stored in the timing controller and compare a grayscale value of the grayscale data with a preset grayscale value; the algorithm controller is configured to determine at least part of a preset region as a high grayscale region in response to a grayscale value of grayscale data corresponding to the at least part of the preset region of the peripheral region being greater than the preset grayscale value; and the algorithm controller is further configured to control the driving board to increase a backlight brightness of the light board corresponding to the high grayscale region, to make a difference in display brightness of the liquid crystal panel between the high grayscale region and the central region less than or equal to 5%.

15. A control method for high grayscale region display, comprising:
determining a high grayscale data of a next-frame display image in a peripheral region of a liquid crystal panel;
detecting a high grayscale region according to the high grayscale data; and
increasing a backlight brightness corresponding to the high grayscale region to make a difference in display brightness between the high grayscale region and a central region of the liquid crystal panel less than or equal to 5%.

16. The control method for high grayscale region display of claim 15, wherein determining the high grayscale data of the next-frame display image in the peripheral region of the liquid crystal panel comprises:
temporarily storing grayscale data of the next-frame display image in the peripheral region in an over driver (OD) of a timing controller;
reading, by an algorithm controller, the grayscale data temporarily stored in the OD;
comparing, by the algorithm controller, a grayscale value of the grayscale data temporarily stored in the OD with a preset grayscale value; and
determining, by the algorithm controller, grayscale data having a grayscale value greater than the preset grayscale value as the high grayscale data.

17. The control method for high grayscale region display of claim 15, wherein detecting the high grayscale region according to the high grayscale data comprises:
in response to the algorithm controller determining that an average value of the grayscale values of all data lines in a sub-region are greater than the preset grayscale value, determining, by the algorithm controller, a number of rows of scan lines to which the high grayscale data is transmitted, wherein the peripheral region comprises four sub-regions sequentially connected to one another and disposed on different sides of the central region; and
in response to an average value of the grayscale values corresponding to all the scan lines in the sub-region being greater than the preset grayscale value, determining, by the algorithm controller, the sub-region as the high grayscale region.

18. The control method for high grayscale region display of claim 15, wherein detecting the high grayscale region according to the high grayscale data comprises:
reading row by row, by the algorithm controller, a preset number of row grayscale data in the sub-region;
determining, by the algorithm controller, whether the preset number of row grayscale data are continuous high grayscale data and locating a detection unit in response to the preset number of row grayscale data being continuous high grayscale data;
continuing to read row by row, by the algorithm controller, the grayscale data in the sub-region to a last row, wherein the peripheral region comprises four sub-regions sequentially connected to one another and disposed on different sides of the central region;
counting, by the algorithm controller, a number of detection units and calculating an area occupied by all the detection units;
calculating, by the algorithm controller, whether a ratio of the area occupied by all the detection units to an area of the sub-region is greater than a preset ratio; and
in response to the ratio of the area occupied by all the detection units to the area of the sub-region being greater than the preset ratio, determining, by the algorithm controller, the sub-region as a high grayscale region.

19. The control method for high grayscale region display of claim 15, wherein increasing the backlight brightness corresponding to the high grayscale region to make the difference in display brightness between the high grayscale region and the central region of the liquid crystal panel less than or equal to 5% comprises:
increasing, by a driving board, a backlight brightness corresponding to the peripheral region;
reducing, by the timing controller, voltages applied at both ends of liquid crystals in the peripheral region;
determining, by using an optical brightness measuring instrument, whether the display brightness of the peripheral region is consistent with the display brightness of the central region;
in response to the display brightness of the peripheral region being consistent with the display brightness of the central region, obtaining a first backlight brightness L1 and a first voltage V1;
repeating the above operations for a plurality of times to obtain a parameter table of a plurality of first backlight brightness L1 and a plurality of first voltages V1;
compiling the parameter table into code to be written into the timing controller;
in response to a high grayscale region existing, reading, by the algorithm controller, a first backlight-voltage pair from the parameter table in the timing controller;
controlling, by the algorithm controller, the driving board to increase the backlight brightness corresponding to the high grayscale region to the first backlight brightness in the first backlight-voltage pair; and
controlling, by the algorithm controller, the timing controller to reduce voltages at both ends of liquid crystals in the high grayscale region to the first voltage.

20. The liquid crystal display apparatus of claim 10, wherein the algorithm controller is configured to determine high grayscale pixels disposed at intersections between a first number of adjacent and consecutive data lines and a second number of adjacent and consecutive scan lines as the detection unit, wherein the first number is greater than or equal to 1, the second number is greater than or equal to 1, and a product of the first number and the second number is the preset number.
